(19) United States
(12) Patent Application Publication
(10) Pub. No.: US 2016/0314184 A1
(43) Pub. Date: Oct. 27, 2016

(54) CLASSIFYING DOCUMENTS BY CLUSTER

(71) Applicant: Google Inc., Mountain View, CA (US)

(72) Inventors: Mike Bendersky, Sunnyvale, CA (US); Jie Yang, Sunnyvale, CA (US); Amitabh Saikia, Mountain View, CA (US); Marc-Allen Cartright, Stanford, CA (US); Sujith Ravi, Santa Clara, CA (US); Balint Miklos, Zurich (CH); Ivo Krka, Zurich (CH); Vanja Josifovski, Los Gatos, CA (US); James Wendt, Los Angeles, CA (US); Luis Garcia Pueyo, San Jose, CA (US)

(21) Appl. No.: 14/697,342

(22) Filed: Apr. 27, 2015

(51) Int. Cl. G06F 17/30

(52) U.S. Cl. CPC G06F 17/30598; G06F 17/30011

(57) ABSTRACT

Methods, apparatus, systems, and computer-readable media are provided for classifying, or “labeling,” documents such as emails en masse based on association with a cluster/template. In various implementations, a corpus of documents may be grouped into a plurality of disjoint clusters of documents based on one or more shared content attributes. A classification distribution associated with a first cluster of the plurality of clusters may be determined based on classifications assigned to individual documents of the first cluster. A classification distribution associated with a second cluster of the plurality of clusters may then be determined based at least in part on the classification distribution associated with the first cluster and a relationship between the first and second clusters.

### BACKGROUND

Automatically-generated documents such as business-to-consumer (“B2C”) emails, invoices, receipts, travel itineraries, and so forth, may more strongly adhere to structured patterns than, say, documents containing primarily personalized prose, such as person-to-person emails or reports. Automatically-generated documents can be grouped into clusters of documents based on similarity, and a template may be reverse engineered for each cluster. Various documents such as emails may be also classified, e.g., by being assigned “labels” such as “Travel,” “Finance,” “Receipts,” and so forth. Classifying documents on an individual basis may be resource intensive, even when automated, due to the potentially enormous amount of data involved. Additionally, classifying individual documents based on their content may raise privacy concerns.

### SUMMARY

The present disclosure is generally directed to methods, apparatus, and computer-readable media (transitory and non-transitory) for classifying documents such as emails based on their association with a particular cluster. Documents may first be grouped into clusters based on one or more shared content attributes. In some implementations, a so-called “template” may be generated for each cluster. Meanwhile, classification distributions associated with the clusters may be determined based on classifications, or “labels,” assigned to individual documents in those clusters. For example, a classification of one cluster could be 20% “Travel,” 40% “Receipts,” and 40% “Finance.” Based on various types of relationships between clusters (and more particularly, between templates representing the clusters), classification distributions for clusters with unclassified documents may be calculated. In some instances, classification distributions for clusters in which all documents are classified may be recalculated. In some implementations, a classification distribution calculated for a cluster may be used to classify all documents in the cluster en masse.

In some implementations, a computer implemented method may be provided that includes the steps of: grouping a corpus of documents into a plurality of disjoint clusters of documents based on one or more shared content attributes; determining a classification distribution associated with a first cluster of the plurality of clusters, the classification distribution associated with the first cluster being based on classifications assigned to individual documents of the first cluster; and calculating a classification distribution associated with a second cluster of the plurality of clusters based at least in part on the classification distribution associated with the first cluster and a relationship between the first and second clusters.

This method and other implementations of technology disclosed herein may each optionally include one or more of the following features.

In some implementations, the method may include classifying documents of the second cluster based on the classification distribution associated with the second cluster. In some implementations, the method may include generating a graph of nodes, each node connected to one or more other nodes via one or more respective edges, each node representing a cluster and including some indication of one or more content attributes shared by documents of the cluster. In some implementations, each edge connecting two nodes may be weighted based on a relationship between clusters represented by the two nodes. In some implementations, the method may further include determining the relationship between clusters represented by the two nodes using cosine similarity or Kullback-Leibler divergence. In some implementations, the method may further include connecting each node to k nearest neighbor nodes using k edges. In various implementations, the k nearest neighbor nodes may have the k strongest relationships with the node, and k may be a positive integer.

In various implementations, each node may include an indication of a classification distribution associated with a cluster represented by that node. In various implementations, the method may further include altering a classification distribution associated with a particular cluster based on m classification distributions associated with m nodes connected to a particular node representing the particular cluster, wherein m is a positive integer less than or equal to k. In various implementations, the altering may be further based on m weights assigned to m edges connecting the m nodes to the particular node.

In various implementations, the method may further include calculating centroid vectors for available classifications of at least the classification distribution associated with the first cluster. In various implementations, the method may further include calculating the classification distribution associated with the second cluster based on a relationship between the second cluster and at least one centroid vector.

In various implementations, the method may further include: generating a first template associated with the first cluster based on one or more content attributes shared among documents of the first cluster; and generating a second template associated with the second cluster based on one or more content attributes shared among documents of the second cluster. In various implementations, the classification distribution associated with the second cluster may be further calculated based at least in part on a similarity between the first and second templates. In various implementations, the method may further include determining the similarity between the first and second templates using cosine similarity or Kullback-Leibler divergence.

In various implementations, generating the first template may include generating a first set of fixed text portions found in at least a threshold fraction of documents of the first cluster, and generating the second template may include generating second set of fixed text portions found in at least a threshold fraction of documents of the second cluster. In various implementations, generating the first template may include calculating a first set of topics based on content of documents of the first cluster, and generating the second template may include calculating a second set of topics based on content of documents of the second cluster. In various implementations, the first and second sets of topics may be calculated using latent Dirichlet allocation.

Other implementations may include a non-transitory computer readable storage medium storing instructions executable by a processor to perform a method such as one or more of the methods described above. Yet another implementation may include a system including memory and one or more processors operable to execute instructions, stored in the memory, to implement one or more modules or engines that, alone or collectively, perform a method such as one or more of the methods described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an environment in which a corpus of documents (e.g., emails) may be classified, or “labeled,” en masse by various components of the present disclosure.

FIG. 2 depicts an example of how a centroid template node may be calculated, in accordance with various implementations.

FIG. 3 depicts an example graph that may be constructed using template nodes that represent clusters of documents, in accordance with various implementations.

FIG. 4 illustrates an example of how a classification distribution associated with one template node may be altered based on, among other things, classification distributions associated with other nodes, in accordance with various implementations.

FIG. 5 depicts a flow chart illustrating an example method of classifying documents en masse, in accordance with various implementations.

FIGS. 6 and 7 depict flow charts illustrating example methods of calculating a classification distribution associated with a template node based on classification distributions associated with other template nodes, in accordance with various implementations.

FIG. 8 schematically depicts an example architecture of a computer system.

### DETAILED DESCRIPTION

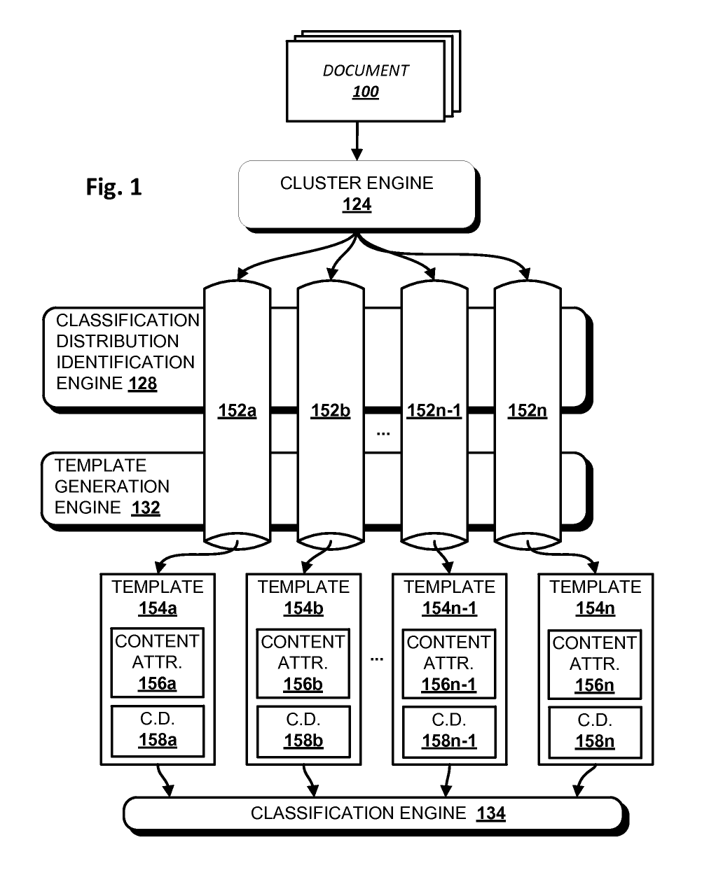

FIG. 1 illustrates an example environment in which documents of a corpus may be classified, or “labeled,” en masse based on association with a particular cluster of documents. While the processes are depicted in a particular order, this is not meant to be limiting. One or more processes may be performed in different orders without affecting how the overall methodology operates. Engines described herein may be implemented using any combination of hardware and software. In various implementations, operations performed by a cluster engine 124, a classification distribution identification engine 128, a template generation engine 132, a classification engine 134, and/or other engines or modules described herein may be performed on individual computer systems, distributed across multiple computer systems, or any combination of the two. These one or more computer systems may be in communication with each other and other computer systems over one or more networks (not depicted).

As used herein, a “document” may refer to a communication such as an email, a text message (e.g., SMS, MMS), an instant message, a transcribed voicemail, or any other textual document, particularly those that are automatically generated (e.g., B2C emails, invoices, reports, receipts, etc.). In various implementations, a document 100 may include various metadata. For instance, an electronic communication such as an email may include an electronic communication address such as one or more sender identifiers (e.g., sender email addresses), one or more recipient identifiers (e.g., recipient email addresses, including cc′d and bcc′d recipients), a date sent, one or more attachments, a subject, and so forth.

A corpus of documents 100 may be grouped into clusters 152a-n by cluster engine 124. These clusters may then be analyzed by template generation engine 132 to generate representations of the clusters, which may be referred to herein as a “templates” 154a-n. In some implementations, cluster engine 124 may be configured to group the corpus of documents 100 into a plurality of clusters 152a-n based on one or more attributes shared among content of one or more documents 100 within the corpus. In some implementations, the plurality of clusters 152a-n may be disjoint, such that documents are not shared among them. In some implementations, cluster engine 124 may have one or more preliminary filtering mechanisms to discard communications that are not suitable for template generation. For example, if a corpus of documents 100 under analysis includes personal emails and B2C emails, personal emails (which may have unpredictably disparate structure) may be discarded.

Cluster engine 124 may group documents into clusters using various techniques. In some implementations, documents such as emails may be clustered based on a sender identity and subject. For example, a pattern such as a regular expression may be developed that matches non-personalized portions of email subjects. Emails (e.g., of a corpus) that match such a pattern and that are from one or more sender email addresses (or from sender email addresses that match one or more patterns) may be grouped into a cluster of emails.

In some implementations, documents may be clustered based on underlying structural similarities. For example, a set of xPaths for an email (e.g., a set of addresses to reach each node in the email's HTML node tree) may be independent of the email's textual content. Thus, the similarity between two or more such emails may be determined based on a number of shared xPaths. An email may be assigned to a particular cluster based on the email sharing a higher number of xPaths with emails of that cluster than with emails of any other cluster. Additionally or alternatively, two emails may be clustered together based on the number of xPaths they share compared to, for instance, a total number of xPaths in both emails.

In some implementations, documents may additionally or alternatively be grouped into clusters based on textual similarities. For example, emails may be analyzed to determine shared terms, phrases, ngrams, ngrams plus frequencies, and so forth. For example, emails sharing a particular number of shared phrases and ngrams may be clustered together. In some implementations, documents may additionally or alternatively be grouped into clusters based on byte similarity. For instance, emails may be viewed as strings of bytes that may include one or both of structure (e.g., metadata, xPaths) and textual content. In some implementations, a weighted combination of two or more of the above-described techniques may be used as well. For example, both structural and textual similarity may be considered, with a heavier emphasis on one or the other.

Once a corpus of documents are grouped into clusters 152a-n, classification distribution identification engine 128 may then determine a classification distribution associated with each cluster. For example, classification distribution identification engine 128 may count emails in a cluster that are classified (or “labeled”) as “Finance,” “Receipts,” “Travel,” etc., and may provide an indication of such distributions, e.g., as pure counts or as percentages of documents of the entire cluster.

Template generation engine 132 may be configured to generate templates 154a-n for the plurality of clusters 152a-n. As noted above, a “template” 154 may refer to various forms of representing of content attributes 156 shared among documents of a cluster. In some implementations, shared content attributes 156 may be represented as “bags of words.” For example, a template 154 generated for a cluster may include, as shared content attributes 156, a set of fixed text portions (e.g., boilerplate, text used for formatting, etc.) found in at least a threshold fraction of documents of the cluster. In some instances, the set of fixed text portions may also include weights, e.g., based on their frequency.

In some implementations, a template T may be defined as a set of documents D^{T}={D₁, . . . Dₙ} that match a so-called “template identifier.” In some implementations, a template identifier may be a <sender, subject-regexp> tuple used to group documents into a particular cluster, as described above. The set of documents D^{T} may be tokenized into a set of unique terms per template, which may, for instance, correspond to a bag of words. Given a template term x, the “support” Sₓ for that term may be defined as a number of documents in D^{T} that contain the term, or formally:

Sₓ^{T}=|{D|DεD^{T}ΛxεD}| (1)

“Fixed text” for a template, or F^{T}, may be defined as a set of terms for which the support Sₓ is greater than some fraction of a number of documents associated with the template, or formally:

$${F}^{T} = \{ x \vert \frac{{S}_{x}^{T}}{\vert {D}^{T} \vert} \geq τ \} \qquad ( 2 )$$

where 0<τ<1 may be set to a particular fraction to remove personal information from the resulting template fixed text representation. The fixed text F^{T} may then be used to represent the template, e.g., as a node in a template node graph (discussed below).

In some implementations, templates may be generated as topic-based representations, rather than as bags of words. Various topic modeling techniques may be applied to documents in a cluster to generate a set of topics. For example, in some implementations, Latent Dirichlet Allocation topic modeling may be applied to fixed text of a template (e.g., the fixed text represented by equation 2). In some instances, weights may be determined and associated with those topics.

In some implementations, each template 154 may include an indication of its classification distribution 158, which as noted above may be determined, for instance, by classification distribution identification engine 128. For example, a template 154 may include percentages of documents within a cluster that are classified in particular ways. In some implementations, a classification (or “label”) distribution of a template T may be formally defined by the following equation:

L^{T}={p(L₁|T), . . . ,p(Lₘ|T)} (3)

Not all documents are necessarily classified, and in some clusters, no documents may be classified. As will be explained further below, in some implementations, templates 154, including their respective content attributes 156 and classification distributions 158, may be stored as nodes of a graph or tree. These nodes and the relationships between them (i.e., edges) may be used to determine classification distributions for clusters with unclassified documents.

In various implementations, classification engine 134 may be configured to classify documents associated with each template (and thus, each cluster). Classification engine 134 may perform these calculations using various techniques. For example, in some implementations, classification engine 134 may use a so-called “majority” classification technique to classify documents of a cluster. With this technique, classification engine 134 may classify all documents associated with a cluster with the classification having the highest distribution in the cluster, according to the corresponding template's existing classification distribution 158. For example, if documents of a given cluster are classified 60% “Finance,” 20% “Travel,” and 20% “Receipts,” classification engine 134 may reclassify all documents associated with that cluster as “Finance.”

The majority classification technique may have limited applicability with clusters where there is no clear majority classification. Accordingly, in some implementations, classification engine 134 may utilize more complex techniques to classify and/or reclassify documents of a cluster 152. For example, classification engine 134 may calculate (if not already known) or recalculate classification distributions associated with one or more of a plurality of clusters 152 based at least in part on classification distributions associated with others of the plurality of clusters 152, and/or based on one or more relationships between the one or more clusters and others of the plurality of clusters 152.

In some implementations, classification engine 134 may organize a plurality of templates 154 into a graph, with each template 154 being represented by a node (also referred to herein as a “template node”) in the graph. In some implementations, two or more nodes of the graph may be connected to each other with edges. Each edge may represent a “relationship” between two nodes. In some implementations, the edges may be weighted, e.g., to reflect strengths of relationships between nodes. In some implementations, a strength of a relationship between two nodes—and thus, a weight assigned to an edge between those two nodes—may be determined based on a similarity between templates represented by the nodes.

“Similarity” between templates (i.e. edge weights) may be calculated using various techniques, such as cosine similarity or Kullback-Leibler (“KL”) divergence, that are described in more detail below. Suppose a weight of a term x in a template T is denoted by w(x, T). For terms in bag-of-words templates, this may be a binary weight, e.g., to avoid over-weighting repeated fixed terms in the template (e.g., repetitions of the word “price” in receipts). For topic representations, this may be a topic weight assignment. Let term probability, p(x|T), be defined as follows:

$$p ( x \vert T ) = \frac{w ( x , T )}{{\sum }_{x ∈ {F}^{T}} w ( x , T )} \qquad ( 4 )$$

Let a smoothed version of term probability, \tilde{p}(x|T), be defined as follows:

$$\tilde{p} ( x \vert T ) = \frac{w ( x , T ) + ε}{{\sum }_{x ∈ {F}^{T}} w ( x , T ) + \vert {F}^{T} \vert ε} \qquad ( 5 )$$

where ε is a small constant used for Laplacian smoothing.

Cosine similarity between two templates, Tᵢ and Tⱼ, which may yield a weighted, undirected edge between their corresponding nodes, may be calculated using an equation such as the following:

$$\frac{{\sum }_{x ∈ {F}^{{T}_{i}} , {F}^{{T}_{j}}} w ( x , {T}_{i} ) w ( x , {T}_{j} )}{\sqrt{{\sum }_{x ∈ {F}^{{T}_{i}}} {w ( x , {T}_{i} )}^{2}} \sqrt{{\sum }_{x ∈ {F}^{{T}_{j}}} {w ( x , {T}_{j} )}^{2}}} \qquad ( 6 )$$

Kullback-Leibler divergence between two templates, Tᵢ and Tⱼ, which may yield a weighted, directed edge between their corresponding nodes, may be calculated using an equation such as the following:

$$exp ( - {\sum }_{x ∈ {F}^{{T}_{i}} ⋂ {F}^{{T}_{j}}} p ( x \vert {T}_{i} ) log \frac{p ( x \vert {T}_{j} )}{\tilde{p} ( x \vert {T}_{j} )} ) \qquad ( 7 )$$

In various implementations, these weighted edges, which as noted above represent relationships between templates, may be used to calculate and/or recalculate classification distributions associated with templates (and ultimately, clusters of documents). Put another way, inter-template relationships, as opposed to purely intra-template relationships, may be used to calculate classification distributions for clusters of documents. Once a classification distribution for a template is calculated, in various implementations, each document in a cluster of documents represented by the template may be classified (or reclassified) based on the calculated classification distribution. Inter-template relationships may be used in various ways to calculate or recalculate classification distributions associated with clusters.

In some implementations, so-called “centroid similarity” may be employed to calculate and/or recalculate classification distributions of clusters. Suppose templates are represented using their fixed text F^{T}, as discussed above. A set of seed templates, [symbol] ^{Li}, may be derived for each classification or “label,” Lᵢ, such that

[symbol]

^{L}^{ᵢ}={T|p(Lᵢ|T)=1} (8)

In other words, seed templates are templates for which corresponding documents are already classified with 100% confidence. For each seed template set [symbol] ^{L}^{ᵢ}, a centroid vector (which itself may be represented as a template node) may be computed by averaging the fixed text vectors F^{T} of its templates. Then, for every non-seed template T with label distribution L^{T}, its similarity (e.g., edge “distance”) to centroids corresponding to the classifications (or “labels”) in L^{T} may be computed. Then, the classification (or “label”) of the most similar (e.g., “closest”) centroid template node to non-seed template T may be assigned to all the documents in non-seed template T.

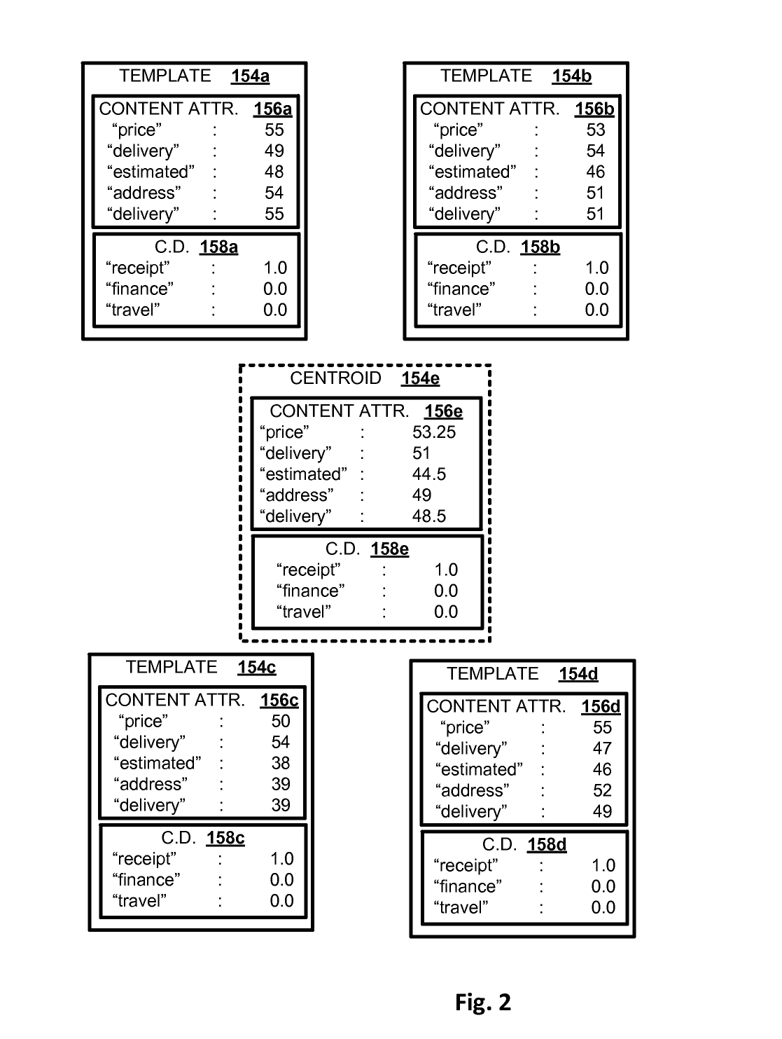

FIG. 2 depicts a non-limiting example of how a centroid template node 154e may be computed. Four templates nodes, 154a-d, have been selected as seed templates because 100% of their corresponding documents are classified as “Receipt.” In other implementations, however, templates may be selected as seeds even if less than 100% of their corresponding documents are classified in a particular way, so long as the documents are classified with an amount of confidence that satisfies a given threshold (e.g., 100%, 90%, etc.). Content attributes 156 associated with each of the four seed templates 154a-d includes a list of terms and corresponding weights. A weight for a given term may represent, for instance, a number of documents associated with a template 154 in which that term is found, or even a raw count of that term across documents associated with the template 154.

In this example, a fifth, centroid template, 154e, has been calculated by averaging the weights assigned to the terms in the four seed templates 154a-d. While the term weights of centroid template 154e are shown to two decimal points in this example, that is not meant to be limiting, and in some implementations, average term weights may be rounded up or down. Similar centroid templates may be calculated for other classifications/labels, such as for “Travel” and “Finance.” Once centroid templates are calculated for each available classification/label, similarities (i.e. edge weights) between these centroid templates and other, non-seed templates 154 (e.g., templates with an insufficient number of classified documents, or heterogeneously-classified documents) may be calculated. A non-seed template 154 may be assigned a classification distribution 158 that corresponds to its “closest” (e.g., most similar) centroid template. In some implementations, documents associated with that non-seed template 154 may then be uniformly classified in accordance with the newly-assigned classification.

Suppose a non-seed template 154 includes twenty emails classified as “Receipts,” twenty emails classified as “Finance,” and twenty unclassified emails. A distance (e.g., similarity) between the non-seed template 154 and “Receipt” and “Finance” centroids may be computed. If the Receipt centroid is the closest (e.g., most similar) to the non-seed template 154, all sixty emails in the cluster represented by the template 154 may be reclassified as “Receipt.” Using this approach, documents associated with templates having uniform classification distributions may be labeled effectively. This approach may also be used to assign labels to documents in clusters in which the majority of the documents are unlabeled.

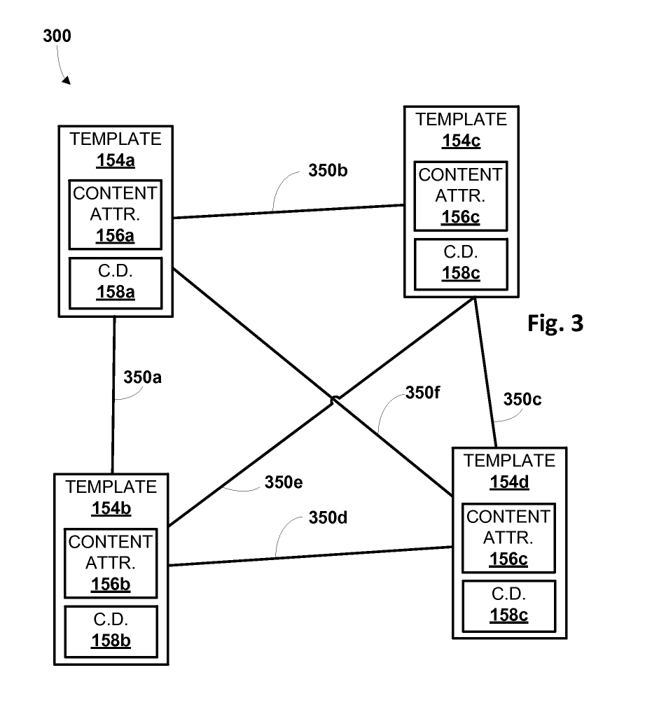

In some implementations, instead of the majority- or centroid-based approaches, so-called “hierarchical propagation” may be employed to calculate and/or recalculate classification distributions of template nodes. Referring now to FIG. 3, classification engine 134 may be configured to first construct a graph 300 in which each template node 154 is connected via an edge 350 to its k nearest (e.g., k most similar, k strongest relationships) neighbor template nodes. (k may be a positive integer). In some implementations, k may be set to various values, such as ten. In this limited example, k=3. Then, classification engine 134 may identify so-called “seed” nodes, e.g., using equation (8) above, and may use them as initial input into a hierarchical propagation algorithm. A convex objective function such as the following may be minimized to determine a so-called “learned” label distribution, \hat{L}:

$$C ( \hat{L} ) = {μ}_{1} {\sum }_{T ∈ S} {‖ {\hat{L}}^{T} - {L}^{T} ‖}^{2} + {μ}_{2} {\sum }_{T ∈ V , {T}^{′} ∈ ( T )} {w}_{T , {T}^{′}} {‖ {\hat{L}}^{T} - {\hat{L}}^{{T}^{′}} ‖}^{2} + {μ}_{3} {\sum }_{T ∈ V} {‖ {\hat{L}}^{T} - U ‖}^{2} \\ such that \\ {\sum }_{l = 1}^{L} {\hat{L}}_{l}^{T} = 1 , ∀ T , l \qquad ( 9 )$$

wherein [symbol] (T) is the neighbor node set of the node T, w_{T,T′} represents the edge weight between template node pairs in graph 300, U is the prior classification distribution over all labels, and μᵢ represents the regularization parameter for each of these components. In some implementations, μ₁=1.0, μ₂=0.1, and μ₃=0.01. \hat{L}^{T} may be the learned label distribution for a template node T, whereas L^{T} represents the true classification distribution for the seed nodes. Equation (9) may capture the following properties: (a) the label distribution should be close to an acceptable label assignment for all the seed templates; (b) the label distribution of a pair of neighbor nodes should be similarly weighted by the edge similarity; (c) the label distribution should be close to the prior U, which can be uniform or provided as input.

In a first iteration of template propagation, seed nodes may broadcast their classification distributions to their k nearest neighbors. Each node that receives a classification distribution from at least one neighbor template node may update its existing classification distribution based on (i) weights assigned to incoming edges 350 through which the classification distributions are received, and (ii) the incoming classification distribution(s) themselves. In subsequent iterations, all nodes for which at least some classification distribution has been determined and/or calculated may broadcast and/or rebroadcast those classification distributions to neighbor nodes. The procedure may repeat until the propagated classification distributions converge. In one experiment, it was observed that the classification distributions converged within approximately ten iterations.

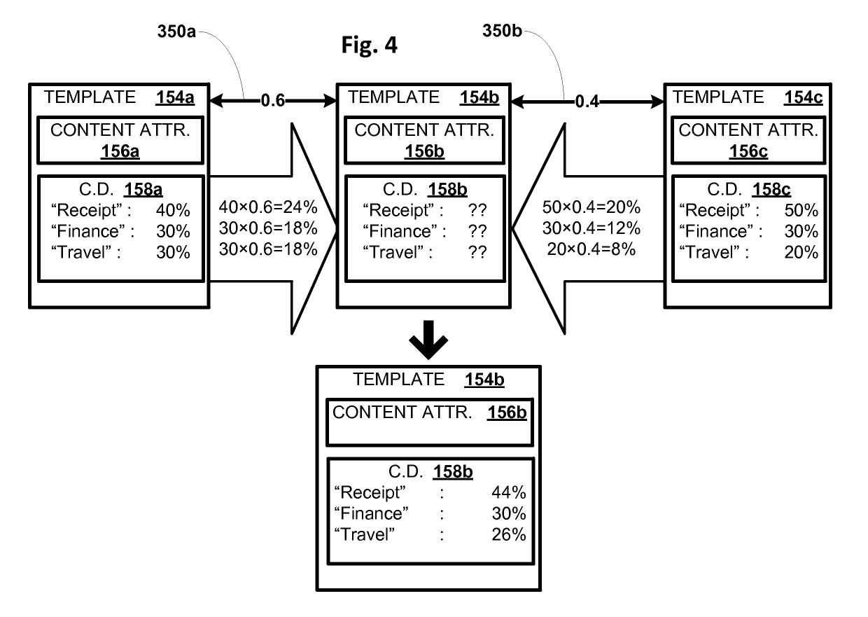

FIG. 4 depicts one example of how known classification distributions of nodes/templates may be used to calculate and/or recalculate classification distributions for other nodes/templates. A first template node 154a includes a classification distribution 158a of 40% “Receipt,” 30% “Finance,” and 30% “Travel.” A second template node 154b includes a classification distribution 158b, but the actual distributions are not yet known. A third template node 154c includes a classification distribution 158c of 50% “Receipt,” 30% “Finance,” and 20% “Travel.” First template node 154a is connected to second template node 154b by an edge 350a with a weight of 0.6 (which as noted above may indicate, for instance, a similarity between content attributes 156a and 156b). Third template node 154c is connected to second template node 154b by an edge 350b with a weight of 0.4. In various implementations, edge weights to/from a particular template node 154 may be normalized to add up to one. Here, only two edges are depicted, but in other implementations, more edges may be used. For example, and as noted above, in some implementations, template nodes 154 may be connected to k=10 nearest neighbors.

The classification distributions of first template node 154a and third template node 154c may be propagated to second template node 154b as indicated by the arrows. Each classification probability (p) of the respective classification distribution 158a may be multiplied by the respective edge weight as shown. The sum of the incoming results for each classification probability may be used as the classification probability for second template node 154b, as shown at the bottom. For example, 40% of documents associated with first template node 154a are classified as “Receipt,” and a weight of edge 350a between first template node 154a and second template node 154b is 0.6, and so the ultimate incoming classification probability at second template 154b for “Receipt” from first template 154a is 24% (40%×0.6=24%). The ultimate incoming classification probability at second template node 154b for “Receipt” from third template node 154c is 20%. If edges 350a and 350b are the only edges to second template node 154b, then classification distribution 158b of second template 154b for “Receipt” adds up to 44%. Incoming classification probabilities for “Finance” and “Travel” are calculated in a similar fashion. The result is that second template node 154b is assigned a classification distribution 158b of 44% “Receipt,” 30% “Finance,” and 26% “Travel.”

Once classification distributions are calculated for each node/template, whether using the centroid approach or hierarchical propagation approach, the calculated classification distributions may be used to classify documents associated with each node/template. In some implementations, the most likely classification of a template (e.g., the classification assigned to the most documents associated with the template) may be assigned to all documents associated with the template, e.g., in accordance with the following equation:

$${L}_{OPT}^{T} = arg {max}_{{L}_{i}} \hat{p} ( {L}_{i} \vert T ) \qquad ( 10 )$$

wherein \tilde{p}(Lᵢ|T) denotes the probability if label/classification Lᵢ according to distribution \hat{L}, after the template propagation stage.

In some implementations, techniques disclosed herein may be used to identify new potential classifications/labels. For example, suppose a particular template representing a cluster of documents is a topic-based template. Suppose further that most or all documents associated with that particular template are not classified/labeled, and/or that a similarity between that template and any templates having known classification distributions (e.g., represented as an edge weight) is unclear or relatively weak. In some implementations, one or more topics of that template having the highest associated weights may be selected as newly-discovered classifications/labels. The newly-discovered classifications/labels may be further applied (e.g., propagated as described above) to other similar templates whose connection to templates with previously-known classifications/labels is unclear and/or relatively weak.

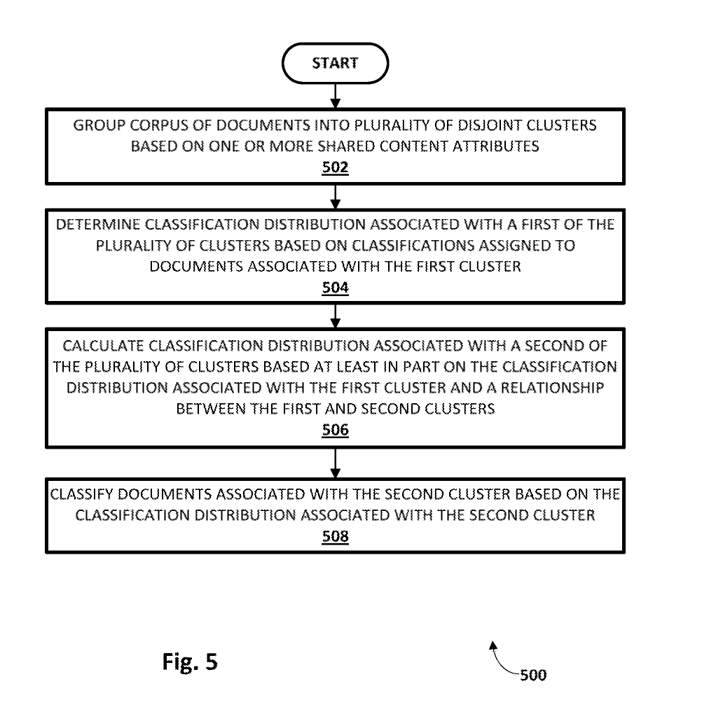

Referring now to FIG. 5, an example method 500 of classifying documents en masse based on their associations with clusters is described. For convenience, the operations of the flow chart are described with reference to a system that performs the operations. This system may include various components of various computer systems, including various engines described herein. Moreover, while operations of method 500 are shown in a particular order, this is not meant to be limiting. One or more operations may be reordered, omitted or added.

At block 502, the system may group a corpus of documents into a plurality of disjoint clusters based on one or more shared content attributes. Example techniques for grouping documents into clusters are described above with respect to cluster engine 124. At block 504, the system may determine a classification distribution associated with at least a first cluster of the plurality of clusters formed at block 502. This classification distribution may be determined based on classifications (or “labels”) assigned to individual documents of the cluster. In some implementations, these individual documents may be classified manually. In some implementations, these individual documents may be classified automatically, e.g., using various document classification techniques.

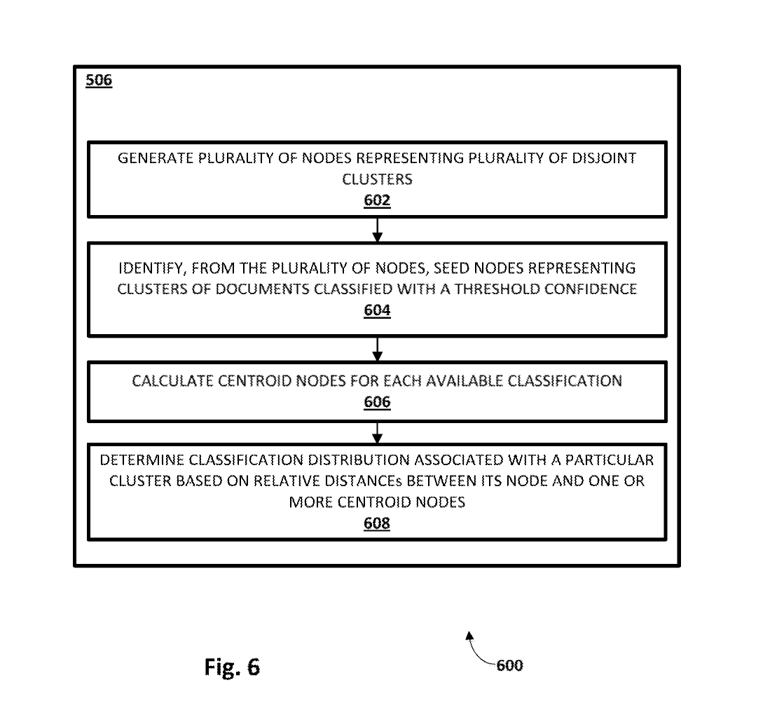

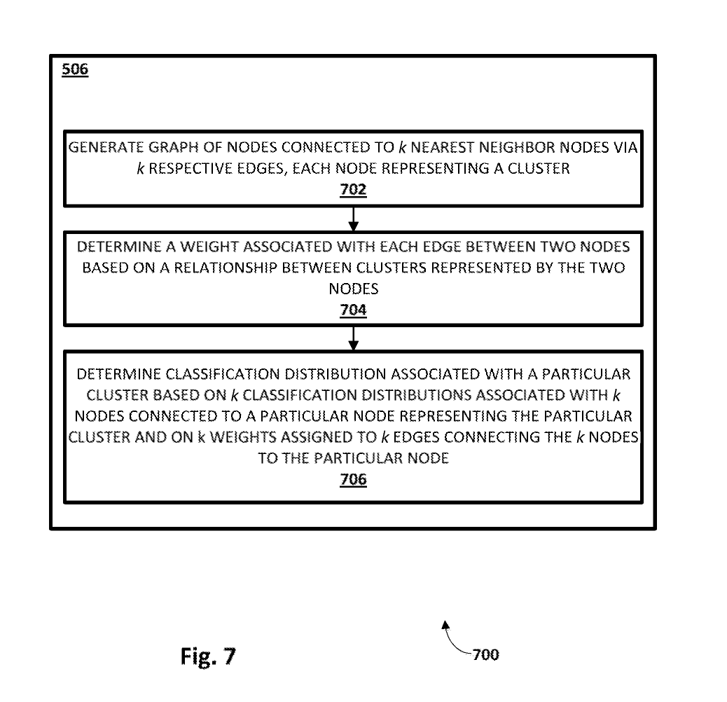

At block 506, the system may calculate a classification distribution associated with a second cluster of the plurality of clusters based at least in part on the classification distribution associated with the first cluster, and based on a relationship between the first and second clusters. Examples of how this operation may be performed were discussed above with regard to the centroid and hierarchical propagation approaches, which are also depicted in FIGS. 6 and 7, respectively. At block 508, the system may classify documents associated with the second cluster based on the classification distribution associated with the second cluster (i.e. determined at block 506. For example, in some implementations, the “most probable” classification (e.g., the classification assigned to the most documents) of a classification distribution may be assigned to all documents associated with the second cluster.

Referring now to FIG. 6, one example method 600 of calculating a classification distribution for a cluster of documents (i.e. block 506 of FIG. 5) using the centroid approach is described. For convenience, the operations of the flow chart are described with reference to a system that performs the operations. This system may include various components of various computer systems, including various engines described herein. Moreover, while operations of method 600 are shown in a particular order, this is not meant to be limiting. One or more operations may be reordered, omitted or added.

At block 602, the system may generate a plurality of nodes representing a plurality of disjoint clusters of documents. As noted above, in some implementations, each node may include a template representation of a particular cluster of documents, which may be a bag of words representation, a topic representation, or some other type of representation. At block 604, the system may identify, from the plurality of nodes, seed nodes that represent particular clusters of documents, e.g., using equation (8) above. In some implementations, nodes representing clusters of documents classified with 100% confidence may be selected as seed nodes. Additionally or alternatively, in some implementations, nodes representing clusters of documents that are 100% classified may be selected as seed nodes.

At block 606, the system may calculate centroid nodes for each available classification (e.g., all identified classifications across a corpus of documents). An example of how a centroid node may be calculated was described above with respect to FIG. 2. At block 608, the system may determine a classification distribution associated with a particular cluster—or in some instances, simply a classification to be assigned to all documents of the particular cluster—based on relative distances between the cluster's representative node and one or more centroid nodes. For example, if the particular cluster's representative template node is most similar (i.e. closest to) a “Finance” centroid, then a classification distribution of that cluster may be altered to be 100% “Finance.”

Referring now to FIG. 7, one example method 700 of calculating a classification distribution for a cluster of documents (i.e., block 506 of FIG. 5) using the hierarchical propagation approach is described. For convenience, the operations of the flow chart are described with reference to a system that performs the operations. This system may include various components of various computer systems, including various engines described herein. Moreover, while operations of method 700 are shown in a particular order, this is not meant to be limiting. One or more operations may be reordered, omitted or added.

At block 702, the system may generate a graph of nodes, such as graph 300 depicted in FIG. 3, wherein each node is connected to its k nearest (i.e. most similar) neighbors via k respective edges. At block 704, the system may determine a weight associated with each edge between two nodes based on a relationship between clusters (and/or templates) represented by the two nodes. For example, if template nodes representing two clusters are very similar, an edge between them may be assigned a greater weight than an edge between two less-similar template nodes. As noted above, in some implementations, edge weights may be normalized so that a sum of edge weights to each node is one.

At block 706, the system may determine a classification distribution associated with a particular cluster based on (i) k classification distributions associated with the k nearest neighbors of the particular cluster's representative node template, and (ii) on k weights associated with k edges connecting the k nearest neighbor nodes to the particular cluster's node. FIG. 4 and its related discussion describe one example of how operations associated with block 706 may be implemented.

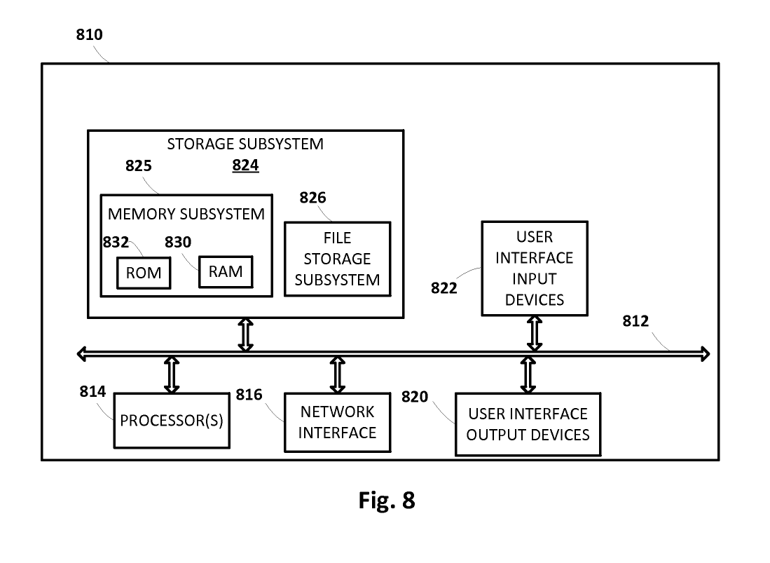

FIG. 8 is a block diagram of an example computer system 810. Computer system 810 typically includes at least one processor 814 which communicates with a number of peripheral devices via bus subsystem 812. These peripheral devices may include a storage subsystem 824, including, for example, a memory subsystem 825 and a file storage subsystem 826, user interface output devices 820, user interface input devices 822, and a network interface subsystem 816. The input and output devices allow user interaction with computer system 810. Network interface subsystem 816 provides an interface to outside networks and is coupled to corresponding interface devices in other computer systems.

User interface input devices 822 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 810 or onto a communication network.

User interface output devices 820 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 810 to the user or to another machine or computer system.

Storage subsystem 824 stores programming and data constructs that provide the functionality of some or all of the modules described herein. For example, the storage subsystem 824 may include the logic to perform selected aspects of methods 500, 600 and/or 700, and/or to implement one or more of cluster engine 124, classification distribution identification engine 128, template generation engine 132, and/or classification engine 440.

These software modules are generally executed by processor 814 alone or in combination with other processors. Memory 825 used in the storage subsystem 824 can include a number of memories including a main random access memory (RAM) 830 for storage of instructions and data during program execution and a read only memory (ROM) 832 in which fixed instructions are stored. A file storage subsystem 826 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 826 in the storage subsystem 824, or in other machines accessible by the processor(s) 814.

Bus subsystem 812 provides a mechanism for letting the various components and subsystems of computer system 810 communicate with each other as intended. Although bus subsystem 812 is shown schematically as a single bus, alternative implementations of the bus subsystem may use multiple busses.

Computer system 810 can be of varying types including a workstation, server, computing cluster, blade server, server farm, or any other data processing system or computing device. Due to the ever-changing nature of computers and networks, the description of computer system 810 depicted in FIG. 8 is intended only as a specific example for purposes of illustrating some implementations. Many other configurations of computer system 810 are possible having more or fewer components than the computer system depicted in FIG. 8.

In situations in which the systems described herein collect personal information about users, or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A computer-implemented method, comprising:
grouping, by a computing system, a corpus of documents into a plurality of disjoint clusters of documents based on one or more shared content attributes;
determining, by the computing system, a classification distribution associated with a first cluster of the plurality of clusters, the classification distribution associated with the first cluster being based on classifications assigned to individual documents of the first cluster; and
calculating, by the computing system, a classification distribution associated with a second cluster of the plurality of clusters based at least in part on the classification distribution associated with the first cluster and a relationship between the first and second clusters.

2. The computer-implemented method of claim 1, further comprising classifying, by the computing system, documents of the second cluster based on the classification distribution associated with the second cluster.

3. The computer-implemented method of claim 1, further comprising generating, by the computing system, a graph of nodes, each node connected to one or more other nodes via one or more respective edges, each node representing a cluster and including some indication of one or more content attributes shared by documents of the cluster.

4. The computer-implemented method of claim 3, wherein each edge connecting two nodes is weighted based on a relationship between clusters represented by the two nodes.

5. The computer-implemented method of claim 4, further comprising determining the relationship between clusters represented by the two nodes using cosine similarity or Kullback-Leibler divergence.

6. The computer-implemented method of claim 4, further comprising connecting each node to k nearest neighbor nodes using k edges, wherein the k nearest neighbor nodes have the k strongest relationships with the node, and k is a positive integer.

7. The computer-implemented method of claim 6, wherein each node includes an indication of a classification distribution associated with a cluster represented by that node.

8. The computer-implemented method of claim 7, further comprising altering a classification distribution associated with a particular cluster based on m classification distributions associated with m nodes connected to a particular node representing the particular cluster, wherein m is a positive integer less than or equal to k.

9. The computer-implemented method of claim 8, wherein the altering is further based on m weights assigned to m edges connecting the m nodes to the particular node.

10. The computer-implemented method of claim 1, further comprising calculating centroid vectors for available classifications of at least the classification distribution associated with the first cluster.

11. The computer-implemented method of claim 10, further comprising calculating the classification distribution associated with the second cluster based on a relationship between the second cluster and at least one centroid vector.

12. The computer-implemented method of claim 1, further comprising:
generating a first template associated with the first cluster based on one or more content attributes shared among documents of the first cluster; and
generating a second template associated with the second cluster based on one or more content attributes shared among documents of the second cluster.

13. The computer-implemented method of claim 12, wherein the classification distribution associated with the second cluster is further calculated based at least in part on a similarity between the first and second templates.

14. The computer-implemented method of claim 13, further comprising determining the similarity between the first and second templates using cosine similarity or Kullback-Leibler divergence.

15. The computer-implemented method of claim 12, wherein:
generating the first template comprises generating a first set of fixed text portions found in at least a threshold fraction of documents of the first cluster; and
generating the second template comprises generating second set of fixed text portions found in at least a threshold fraction of documents of the second cluster.

16. The computer-implemented method of claim 12, wherein
generating the first template comprises calculating a first set of topics based on content of documents of the first cluster; and
generating the second template comprises calculating a second set of topics based on content of documents of the second cluster;
wherein the first and second sets of topics are calculated using latent Dirichlet allocation.

17. A system including memory and one or more processors operable to execute instructions stored in the memory, comprising instructions to:
group a corpus of documents into a plurality of disjoint clusters of documents based on one or more shared content attributes;
determine a classification distribution associated with a first cluster of the plurality of disjoint clusters, the classification distribution associated with the first cluster being based on classifications assigned to individual documents of the first cluster;
calculate a classification distribution associated with a second cluster of the plurality of disjoint clusters based at least in part on the classification distribution associated with the first cluster and a relationship between the first and second clusters; and
classify documents of the second cluster based on the classification distribution associated with the second cluster.

18. The system of claim 17, further comprising instructions to:
generate a graph of nodes, each node connected to one or more other nodes via one or more respective edges, wherein each node represents a cluster and each edge connecting two nodes is weighted based on a relationship between clusters represented by the two nodes; and
alter a classification distribution associated with a particular cluster based on:
one or more classification distributions associated with one or more nodes connected to a particular node representing the particular cluster; and
one or more weights assigned to one or more edges connecting the one or more nodes to the particular node.

19. The system of claim 17, further comprising instructions to:
calculate one or more centroid vectors for one or more available classifications of at least the classification distribution associated with the first cluster; and
calculate the classification distribution associated with the second cluster based on a relationship between the second cluster and at least one of the one or more centroid vectors.

20. At least one non-transitory computer-readable medium comprising instructions that, in response to execution of the instructions by a computing system, cause the computing system to perform the operations of:
grouping a corpus of documents into a plurality of disjoint clusters of documents based on one or more shared content attributes;
determining a classification distribution associated with a first cluster of the plurality of disjoint clusters, the classification distribution associated with the first cluster being based on classifications assigned to individual documents of the first cluster; and
calculating a classification distribution associated with a second cluster of the plurality of disjoint clusters based at least in part on the classification distribution associated with the first cluster and a relationship between the first and second clusters.
